(19) United States
(12) Patent Application Publication
(10) Pub. No.: US 2004/0205766 A1
(43) Pub. Date: Oct. 14, 2004

(54) Application service system and method for client devices on intranet

(75) Inventors: Jaeshin Lee, Seoul (KR); Hyungyoo Yook, Seoul (KR); Kyounghoon Yi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/726,613

(22) Filed: Dec. 4, 2003

(30) Foreign Application Priority Data
Jan. 21, 2003 (KR) 10-2003-0004011

(51) Int. Cl. G06F 15/16; H04Q 7/24; G06F 3/00; G06F 13/00

(52) U.S. Cl. 719/311; 709/249; 370/338

(57) ABSTRACT

An application service system and method for client devices on an intranet is provided. The application service system includes a service-providing server for registering applications for client devices on the intranet, the applications being provided from a plurality of service developers through a wired/wireless communication network, and providing a selected application, and an application service module for searching a list of applications registered in the service-providing server and providing an application, selected from the list of searched applications, corresponding to information on the devices installed in the intranet of a user.

This application claims the priority of Korean Patent Application No. 10-2003-0004011, filed on Jan. 21, 2003, in the Korean Intellectual Property Office, the disclosure of which is incorporated herein in its entirety by reference.

### BACKGROUND OF THE INVENTION

1. Field of Invention

The present invention relates to an application service system and a method for client devices on an intranet. More particularly, the present invention relates to an application service system and method for client devices on an intranet, wherein an appropriate application program can be provided in accordance with the intranet environment of a user, by searching for a service-providing server in which service application programs, provided from a service developer, for the client devices on the intranet are registered and by selecting the appropriate application from a list of the searched application programs in accordance with the user's intranet environment.

2. Description of the Related Art

An intranet is generally a private network including all connections through one or more gateway computers connected to the external Internet. The intranet may be configured to comprise a plurality of local area networks connected to each other or to use a dedicated line within a wide area network.

A home network has been provided as a typical example of such an intranet. The home network is configured to connect information and communication equipment such as a computer, facsimile machine, modem and telephone set; A/V equipment such as a TV, DVD player and VCR; and electric home appliances such as an electric rice cooker, refrigerator and washing machine through one network, and to control the connected equipment and appliances. Further, a system of connecting the equipment and appliances scattered within a home through a common virtual computing environment called middleware and providing application programs thereon has been suggested.

In a home network system, client devices corresponding to objects of control are controlled in accordance with control commands of an external user, which are received through a home gateway. As home gateway technology advances, multiple services can be provided to the devices in the home through an external network. Further, the home network devices are updated and upgraded through relevant service application programs (hereinafter, referred to as applications) provided by a service developer, so that a variety of services can be provided.

In order to use these applications provided for the client devices of a home network system, the user should receive relevant applications provided as a group from a service-providing server of a service provider in which the applications provided from a service developer have been registered and install them in home gateway equipment. Otherwise, the user should check a list of registered services after connecting with the service-providing server and learn about each of the respective services to check which services are applicable to which devices operating in his/her own home and then selectively use the relevant applications.

By way of example, a case where an application for allowing a user 10 to perform an on/off operation and other detailed operations of an air conditioner, a washing machine and an audio device is additionally provided in a home network in which the operation of these home network devices can be controlled will be described. In order to use the application, the user 10 accesses a service-providing server 30 in which the relevant application has been registered, through a wired/wireless communication network 40.

Then, the user 10 who has accessed the service-providing server 30 selects an item with a desired function from a list of registered applications and downloads the selected application through a home gateway 50 so as to install the downloaded application in a home network middleware 51.

The application downloaded as such by the user 10 is implemented in home network devices 70 (e.g., an air conditioner, a washing machine and an audio device) connected to the home network middleware 51 of the user so that the user can perform detailed operation of the home network devices 70.

That is, the user downloads the application from the service-providing server 30 and then executes the downloaded application in the client in order to update and upgrade client devices of the intranet. However, if the application selected and downloaded by the user is not appropriate for the user's intranet environment, there is a problem in that the cost and time used in the download process are wasted.

To avoid this problem, users should fully know the conditions of the respective devices and their intranet environment. Accordingly, there is another problem in that users who lack this information or are not skillful in manipulating devices are reluctant to download the application.

Consequently, there is a further problem in that a variety of application programs provided for the respective devices in an intranet environment cannot be widely distributed.

Therefore, there is a need to provide a method of allowing users to selectively receive applications appropriate for their own intranet environment and to efficiently use the received applications.

### SUMMARY OF THE INVENTION

It is an exemplary object of the present invention to select an application suitable for a predetermined intranet environment from a variety of applications provided by a service developer through a service-providing server and provide the selected application to a user.

It is another exemplary object of the present invention to allow a user to efficiently utilize a variety of application services through a suitable application selected in accordance with a predetermined intranet environment.

According to an illustrative, non-limiting aspect of the present invention for achieving the aforementioned exemplary objects, there is provided an application service system for client devices on an intranet, which comprises a service-providing server for registering applications, provided from a plurality of service developers through a wired/wireless communication network, for client devices on the intranet and providing an application selected from a list of registered applications according to information on the client devices installed in the intranet.

According to another illustrative, non-limiting embodiment of the present invention, there is provided an application service system for client devices on an intranet, which comprises an application service module for accessing a service-providing server in which applications, provided from a plurality of service developers through a wired/wireless communication network, for client devices on the intranet are registered, searching a list of applications, and providing applications, selected from the list of searched applications, corresponding to information on the devices installed in the intranet of a user.

According to a yet another illustrative, non-limiting embodiment of the present invention, there is provided an application service system for client devices on an intranet, which comprises a service-providing server for registering applications, provided from a plurality of service developers through a wired/wireless communication network, for client devices on the intranet and providing a selected application, and an application service module for searching a list of applications registered in the service-providing server and providing an application, selected from the list of searched applications, corresponding to information on the devices installed in the intranet of a user.

According to another illustrative, non-limiting aspect of the present invention for achieving the aforementioned exemplary objects, there is provided an application service method for client devices on an intranet, which comprises an application registration step for registering applications, provided from service developers, for home network devices in a service-providing server, and an application providing step for providing an application selected from a list of registered applications according to information on the devices installed in the intranet of a user.

According to another illustrative, non-limiting embodiment of the present invention, there is provided an application service method for client devices on an intranet, which comprises an application search step for accessing a service-providing server in which applications, provided from service developers, for client devices on the intranet are registered and searching a list of the registered applications, and an application providing step for providing the list of searched applications selected in accordance with an intranet environment of a user and receiving the selected applications from the service-providing server in response to the selection of the user.

According to yet another illustrative, non-limiting embodiment of the present invention, there is also provided an application service method for client devices on an intranet, which comprises an application registration step for registering applications for client devices on the intranet in a service-providing server, said applications being provided from service developers, an application search step for accessing the service-providing server and searching a list of registered applications, an application list providing step for selecting the list of searched applications in accordance with an intranet environment of a user and providing the list of selected applications to the user, and an application providing step for receiving a specific application from the service-providing server upon request for the specific application if the user selects the specific application from the list of applications.

### BRIEF DESCRIPTION OF THE DRAWINGS

The above and other exemplary objects, features and advantages of the present invention will become apparent from the following description of an illustrative, non-limiting embodiment given in conjunction with the accompanying drawings, in which:

FIG. 1 is a diagram schematically illustrating a configuration of a conventional application service system for home network devices;

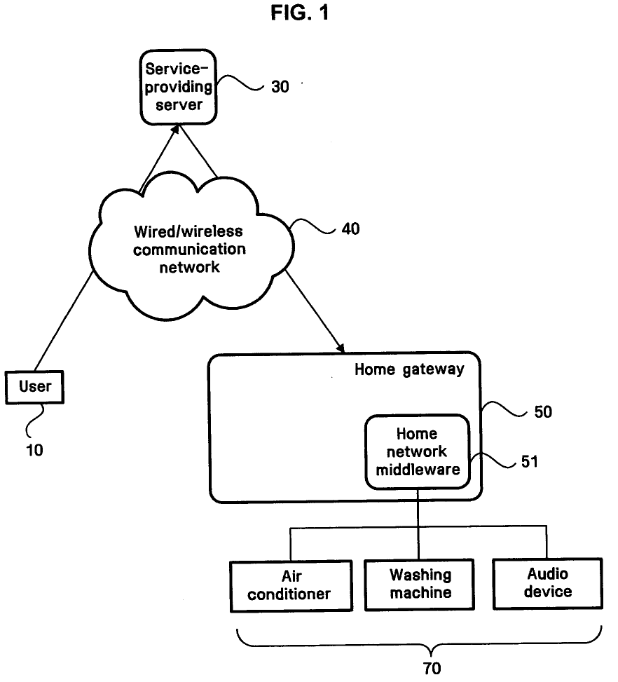

FIG. 2 is a diagram schematically illustrating a configuration of an application service system for home network devices according to an exemplary embodiment of the present invention; and

FIG. 3 is a view illustrating an operating process of an application service method for home network devices according to another exemplary embodiment of the present invention.

### DESCRIPTION

Hereinafter, the configuration and operation of an application service system for client devices on an intranet according to the present invention will be described with reference to the accompanying drawings and using a home network system as a typical example of an intranet.

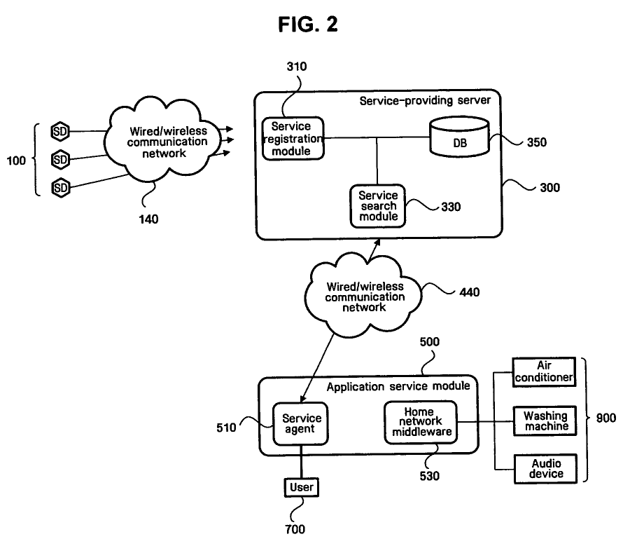

FIG. 2 is a diagram schematically illustrating a configuration of an application service system for home network devices according to an illustrative, non-limiting embodiment of the present invention.

Referring to FIG. 2, the application service system of the present invention comprises a service-providing server 300 for integrating and registering applications, provided from a plurality of service developers 100 through a wired/wireless communication network 140, for a home network and providing the applications upon request of a user 700, and an application service module 500 for searching a list of applications registered in the service-providing server 300 and providing a desired application selected from the list of searched applications in accordance with a home network environment of the user 700.

The service-providing server 300 comprises a service registration module 310 for registering meta information and location information for a variety of applications provided from the respective service developers 100, and a service search module 330 for searching the list of applications registered in the service registration module 310 and providing search results when the application service module 500 requests to search the applications registered in the service registration module 310.

In addition, the service-providing server 300 further comprises a database (DB) 350 in which meta information and location information on the applications provided by the service developers 100 are stored.

The location information represents a path for downloading applications provided from the respective service developers 100 and corresponds to locations of application servers of the service developers 100.

The meta information is application information used to distinguish service functions provided through packaged applications and comprises a component for operation, type of device used for the operation, a service location and the ID of a service provider.

The ID of the service provider is used in the application service module 500 to search for applications registered in the DB 350 through the service registration module 310. The applications registered in the DB 350 are searched within a search range of IDs designated by the application service module 500.

The application service module 500 searches the list of applications registered in the service-providing server 300 through the service-providing server 300 and home network middleware 530 connected with each other via a wired/wireless communication network 440, and collects information on devices 900 operating under the home network environment of the user 700 to provide only the applications selected in accordance with the home network environment of the user (e.g., home gateway). Further, the application service module 500 comprises a service agent 510 for providing a user 700 with applications appropriate for the home network environment of the user 700, and the home network middleware 530 for integrating devices 900 scattered in a home so as to build a common virtual computing environment and providing a variety of applications.

That is, the service agent 510 periodically (e.g., weekly or monthly) accesses the service-providing server 300 populated by the service developers 100, searches the list of registered applications within a scope (e.g., a range of dates updated in this month or a range of devices corresponding to an applicable object) defined by the user 700, and collects information on devices 900 installed in the home and current components through the home network middleware 530. Then, the service agent 510 compares the list of searched applications with the collected information on the devices so as to collect only the applications executable with the currently operating devices and provides the collected applications to the user 700.

In such a case, the list of collected applications can be displayed on an additional display unit of the user. Thus, the user 700 can select desired applications from the displayed list of applications and implement the selected applications in his/her own home network.

For reference, in the aforementioned application service system for home network devices according to the preceding illustrative embodiment of the present invention, all modules may be configured in hardware, some modules in hardware and some modules in software, or all modules in software.

Therefore, it will fall within the scope and spirit of the present invention that the application service system for home network devices according to the illustrative embodiment of the present invention described herein may be configured in either hardware or software, and it will also be apparent that various changes and modifications thereof can be made thereto without departing from the scope and spirit of the present invention.

Furthermore, although it has been described that the application service system for home network devices becomes a single system including a service-providing server and an application service module, the applications can be provided to home network devices through any one of a number of service-providing servers and application service modules.

An exemplary method of providing applications according to the present invention using the application service system for home network devices configured as such will be hereinafter described with reference to the accompany drawings.

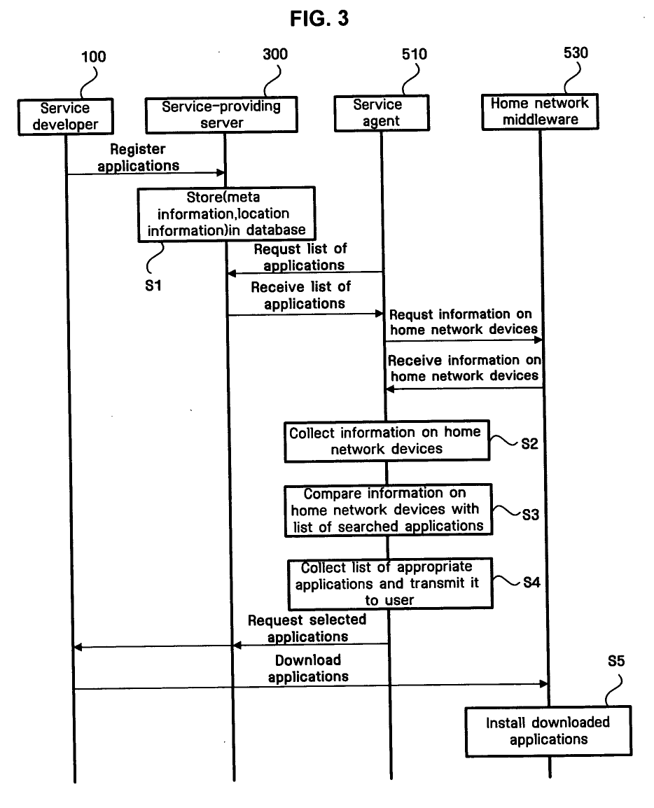

FIG. 3 shows an operating process of an application service method for home network devices according to an illustrative, non-limiting embodiment of the present invention.

Referring to FIG. 3, the application service method of the present invention largely comprises the steps of registering information on applications for the home network devices provided from a service developer 100 in a service-providing server 300, searching a list of the registered applications by accessing the service-providing server 300, and providing a desired application selected from the list of searched applications in accordance with the home network environment of a user 700.

First, if information on an application corresponding to a specific service developed by a service provider is provided from respective service developers 100, the service provider registers location information for application download and meta information on the application provided to the service-providing server 300 through a service registration module 310.

Further, the service registration module 310 causes the location information and the meta information on the registered specific application to be stored in a database 350 (S1).

Such a service registration step is performed whenever a service developer develops any services.

Then, the application service module 500 periodically accesses the service-providing server 300 every period of time set by the user and searches the list of applications registered in the database 350 through a service search module 330.

That is, if the ID of a service developer 100 is designated in the application service module 500, the service search module 330 searches the desired list of applications of the service developer from the database 350 based on the designated ID.

Next, a service agent 510 of the application service module 500 collects information on devices 900 currently operating in a home network through home network middleware 530 (S2) and compares the collected information with the list of searched applications (S3).

The service agent 510 collects only applications appropriate for the home network of the user based on comparison results of the list of searched applications and the collected information on the home network devices and provides the user 700 with the collected applications (S4).

The user 700 receives the list of applications provided by the service agent 510 through a predetermined display unit and selects desired application(s) from the list of applications.

In response to the user's selection of a specific application, the service agent 510 accesses the service-providing server 300 to request the selected application. Consequently, the relevant application is downloaded from the service developer 100 and then installed in the home network environment of the user (S5).

Through this process, the user can install the desired application in his/her own home network and use the desired service.

For example, if an application for performing a service function of providing a surround sound effect by linking an audio device and a digital TV among the devices 900 operating in a home network has been developed by the service developer 100, the service developer 100 registers location information and meta information including the description of the relevant application in the service-providing server 300.

The service agent 510 of the application service module that periodically searches the service-providing server 300 searches a list of applications provided from the service developer 100 having an ID designated by the user. The service agent 510 also collects the information on the home network devices 900 installed in the home network of the user through the home network middleware 530.

The information on the devices 900 operating in the home network of the user, which is collected through the above process, is compared with the list of searched applications, and only applications appropriate for the user's home network devices 900 are collected so that they can be provided to the user. In a case where the application for surround sound service provided from the service developer 100 can be implemented in the home network for the digital TV and the audio device of the user, the relevant application would be included in the list of collected applications.

The user receives and checks the list of collected applications from the service agent 510, and the user also selects a relevant item from the list of applications if intending to use the application for the surround sound service.

After the application for the surround sound service has been selected, the service agent 510 transmits the selected application item to the service-providing server 300 and causes the relevant application to be downloaded from the service developer 100 to the user's home network.

Therefore, the user can use the surround sound service through the digital TV and audio device operating in his/her own home network by executing the downloaded application.

According to the present invention, a user who uses an intranet configured in a predetermined computing environment receives only applications selected in accordance with his/her own intranet, thus efficiently utilizing received applications to update and upgrade client devices.

Further, since the user receives and uses applications selected in accordance with his/her own intranet environment, the development of applications by a plurality of service developers can be advantageously promoted.

The present invention has been described in connection with the illustrative, non-limiting embodiment of the home network system shown in the accompanying drawings. It can also be understood by those skilled in the art that various changes and modifications can be made thereto without departing from the scope and spirit of the present invention defined by the claims. Therefore, the true scope of the present invention should be defined by the technical spirit of the appended claims.

What is claimed is:

1. An application service system for client devices on an intranet, comprising:
a service-providing server for registering applications for client devices on the intranet, said applications provided from a plurality of service developers through a wired/wireless communication network, and providing an application selected from a list of registered applications according to information on the client devices installed in the intranet.

2. The system according to claim 1, wherein the service providing server comprises:
a service registration module for registering location information on each application provided from the service developers together with meta information; and
a service search module for searching the list of applications registered in the service registration module and providing search results when an application service module requests to search the applications registered in the service registration module.

3. The system according to claim 2, wherein the location information represents a path for downloading the applications provided from the respective service developers.

4. The system according to claim 3, wherein the meta information is application information including a component for operation, a type of device used for the operation, a service location and an ID of a service developer, said component for operation provided for distinguishing service functions of the applications.

5. An application service system for client devices on an intranet, comprising:
an application service module for accessing a service-providing server in which applications for client devices on the intranet are registered, said applications provided from a plurality of service developers through a wired/wireless communication network, searching a list of applications, and providing applications, selected from the list of searched applications, corresponding to information on the devices installed in the intranet of a user.

6. The system according to claim 5, wherein the application service module is a gateway for connecting a computing environment of the intranet with the service-providing server.

7. The system according to claim 5, wherein the application service module comprises a service agent for searching the list of applications registered in the service-providing sever, collecting information on the devices operating in the intranet of the user, and providing only the applications selected in accordance with the user's intranet.

8. An application service system for client devices on an intranet, comprising:
a service-providing server for registering applications for client devices on the intranet, said applications provided from a plurality of service developers through a wired/wireless communication network, and providing a selected application; and
an application service module for searching a list of applications registered in the service-providing server and providing an application, selected from the list of searched applications, corresponding to information on the devices installed in the intranet of a user.

9. The system according to claim 8, wherein the service providing server comprises:
a service registration module for registering location information for each application provided from the service developers together with meta information; and
a service search module for searching the list of applications registered in the service registration module and providing search results when an application service module requests to search the applications registered in the service registration module.

10. The system according to claim 9, wherein the location information represents a path for downloading the applications provided from the respective service developers.

11. The system according to claim 10, wherein the meta information is application information including a component for operation, a type of device used for the operation, a service location and an ID of a service developer, said component for operation provided for distinguishing service functions of the applications.

12. The system according to claim 8, wherein the application service module is a gateway for connecting a computer environment of the intranet with the service-providing server.

13. The system according to claim 8, wherein the application service module comprises a service agent for searching the list of applications registered in the service-providing server, collecting information on the devices operating in the intranet of the user, and providing only the applications selected in accordance with the user's intranet.

14. An application service method for client devices on an intranet, comprising:
an application registration step for registering applications for home network devices in a service-providing server, said applications provided from service developers; and
an application providing step for providing an application selected from a list of registered applications according to information on the devices installed in the intranet of a user.

15. The method according to claim 14, wherein the application registration step further comprises the step of storing meta information and a download path for the service applications, provided from the service developers, in a database.

16. The method according to claim 14, wherein the application providing step comprises:
comparing the list of searched applications with information on the home network devices collected through an intranet gateway of the user;
selecting only applications appropriate for the intranet of the user from the list of searched applications based on the comparison results; and
providing a list of the selected applications to the user, and requesting the service-providing server to transmit a specific application if the specific application is selected by the user.

17. The method according to claim 14, further comprising downloading applications to and executing the downloaded applications in the intranet gateway of the user, allowing the user to utilize a relevant service.

18. An application service method for client devices on an intranet, comprising:
an application search step for accessing a service-providing server in which applications for client devices on the intranet are registered, said applications provided from service developers, and searching a list of the registered applications; and
an application providing step for providing the list of searched applications selected in accordance with an intranet environment of a user and receiving the selected applications from the service-providing server in response to a selection of the user.

19. The method according to claim 18, wherein the application registration step further comprises storing meta information and a download path for the applications, provided from the service developers, in a database.

20. The method according to claim 18, wherein the application providing step comprises:
comparing the list of searched applications with information on the client devices collected through an intranet gateway of the user;
selecting only applications appropriate for the intranet of the user from the list of searched applications based on the comparison results; and
providing a list of the selected applications to the user, and requesting the service-providing server to transmit a specific application if the specific application is selected by the user.

21. The method according to claim 18, further comprising downloading applications to and executing the downloaded applications in the intranet gateway of the user, allowing the user to utilize a relevant service.

22. An application service method for client devices on an intranet, comprising:
an application registration step for registering applications for client devices on the intranet in a service-providing server, said applications provided from service developers:
an application search step for accessing the service-providing server and searching a list of the registered applications:
an application list providing step for selecting the list of searched applications in accordance with an intranet environment of a user and providing the list of selected applications to the user; and
an application providing step for receiving a specific application from the service-providing server if the user selects the specific application from the list of selected applications.

23. The method according to claim 22, wherein the application registration step further comprises the step of storing meta information and a download path for the service applications, provided from the service developers, in a database.

24. The method according to claim 22, wherein the application providing step comprises:
comparing the list of searched applications with information on the home network devices collected through an internet gateway of the user;
selecting only applications appropriate for the intranet of the user from the list of searched applications based on the comparison results; and
providing a list of the selected applications to the user, and requesting the service-providing server to transmit a specific application if the specific application is selected by the user.

25. The method according to claim 22, further comprising downloading applications to the intranet gateway of the user and executing the downloaded applications in the intranet gateway of the user, allowing the user to utilize a relevant service.
